(19) United States
(12) Patent Application Publication
(10) Pub. No.: US 2024/0376922 A1
(43) Pub. Date: Nov. 14, 2024

(54) PLATE CONNECTION ASSEMBLY, CONNECTOR FOR CONNECTING PLATES AND BOX

(71) Applicants: FUJIAN DAZHUANG BAMBOO INDUSTRY TECHNOLOGY CO., LTD., JianOu City (CN); Hangzhou Yuhou Technology Co., Ltd., Hangzhou City (CN); DASSO INTERNATIONAL INC., New York, NY (US)

(72) Inventors: Haiying Shen, Hangzhou City (CN); Hai Lin, Songyuan (CN); Yueping Dai, JianOu City (CN); Zhijian Jian, JianOu City (CN); Xiaojian Li, JianOu City (CN); Lijian Hao, JianOu City (CN)

(73) Assignees: FUJIAN DAZHUANG BAMBOO INDUSTRY TECHNOLOGY CO., LTD., JianOu City (CN); Hangzhou Yuhou Technology Co., Ltd., Hangzhou City, ZJ (CN); DASSO INTERNATIONAL INC., New York, NY (US)

(21) Appl. No.: 18/658,504

(22) Filed: May 8, 2024

(30) Foreign Application Priority Data
May 9, 2023 (CN) 202321094770.8
May 9, 2023 (CN) 202321096508.7

(51) Int. Cl. F16B 12/46

(52) U.S. Cl. CPC F16B 12/46

(57) ABSTRACT

A plate connection assembly, a connector for connecting plates and a box are provided. The plate connection assembly includes a connector, a first plate and a second plate. The connector includes a first connecting part and a second connecting part extending along a length direction of the connector. The first plate has a third connecting part adjacent to an end of the first plate and extending along a width direction of the first plate. The second plate has a fourth connecting part adjacent to an end of the second plate and extending along a width direction of the second plate. The third connecting part is engaged with the first connecting part, and the fourth connecting part is engaged with the second connecting part.

### FIELD

The present disclosure relates to a technical field of plate connection, in particular to a plate connection assembly, a connector for connecting plates and a box.

### BACKGROUND

In the related art, adjacent side plates of a wooden or bamboo storage box are connected by a comb-tooth tenon structure on the side plates, each side plate has a plurality of trapezoidal comb-tooth tenons arranged at intervals along its width direction, and the plurality of comb-tooth tenons of the adjacent side plates are engaged with each other. Moreover, in order to avoid the separation of the adjacent side plates, the glue is applied between the plurality of comb-tooth tenons to bond the adjacent side plates together.

However, the above connection manner has high requirements for processing and assembling technologies, so that it is difficult to assemble, and the mortise and tenon structures need to be processed at the edges of the side plates, so that it is difficult to process, thus resulting in a high cost and a poor universality. In the related art, both the wooden and bamboo storage boxes are packaged and transported after being assembled, thus resulting in a large volume, a large occupied space, inconvenient transportation and a high cost.

### SUMMARY

Embodiments of a first aspect of the present disclosure provide a plate connection assembly. The plate connection assembly includes: a connector including a first connecting part and a second connecting part extending along a length direction of the connector; and a first plate and a second plate. The first plate has a third connecting part adjacent to an end of the first plate and extending in a width direction of the first plate, and the second plate has a fourth connecting part adjacent to an end of the second plate and extending in a width direction of the second plate. The third connecting part is engaged with the first connecting part, and the fourth connecting part is engaged with the second connecting part.

Embodiments of a second aspect of the present disclosure provide a connector for connecting plates. The connector includes a first connecting part and a second connecting part. The first connecting part extends along a length direction of the connector and is configured to be engaged with a first plate. The second connecting part extends along the length direction of the connector and is configured to be engaged with a second plate. The first connecting part includes a first engaging groove or a first engaging protrusion, and the second connecting part includes a second engaging groove or a second engaging protrusion.

Embodiments of a third aspect of the present disclosure provide a box. The box includes a bottom plate, a plurality of side plates and a plurality of connectors. The plurality of side plates are connected with the bottom plate, adjacent side plates include a first plate and a second plate, and adjacent ends of the first plate and the second plate are connected with each other through the connector. The connector includes a first connecting part and a second connecting part extending along a length direction of the connector. The first plate has a third connecting part adjacent to an end of the first plate and extending in a width direction of the first plate, and the second plate has a fourth connecting part adjacent to an end of the second plate and extending in a width direction of the second plate. The third connecting part is engaged with the first connecting part, and the fourth connecting part is engaged with the second connecting part.

### BRIEF DESCRIPTION OF THE DRAWINGS

FIG. 1 is a partial plan view of a plate connection assembly according to a first embodiment of the present disclosure.

FIG. 2 is a partial perspective view of a plate connection assembly according to a first embodiment of the present disclosure.

FIG. 3 is an enlarged view of region A in FIG. 2.

FIG. 4 is a schematic view of a first plate of a plate connection assembly according to a first embodiment of the present disclosure.

FIG. 5 is an enlarged view of region B in FIG. 4.

FIG. 6 is a schematic view of a second plate of a plate connection assembly according to a first embodiment of the present disclosure.

FIG. 7 is an enlarged view of region C in FIG. 6.

FIG. 8 is a perspective view of a connector of a plate connection assembly according to a first embodiment of the present disclosure.

FIG. 9 is a perspective view of a connector of a plate connection assembly according to a first embodiment of the present disclosure from another angle.

FIG. 10 is an end view of a connector of a plate connection assembly according to a first embodiment of the present disclosure.

FIG. 11 is a perspective view of a box with a plate connection assembly according to a first embodiment of the present disclosure.

FIG. 12 is an end view of a connector of a plate connection assembly according to a second embodiment of the present disclosure.

FIG. 13 is an end view of a connector of a plate connection assembly according to a third embodiment of the present disclosure.

FIG. 14 is an end view of a connector of a plate connection assembly according to a fourth embodiment of the present disclosure.

FIG. 15 is a partial schematic view of a plate connection assembly according to a fifth embodiment of the present disclosure.

FIG. 16 is a schematic view of a first plate (a second plate) of a plate connection assembly according to a fifth embodiment of the present disclosure.

FIG. 17 is a perspective view of a connector of a plate connection assembly according to a fifth embodiment of the present disclosure.

FIG. 18 is a perspective view of a connector of a plate connection assembly according to a fifth embodiment of the present disclosure from another angle.

FIG. 19 is an end view of a connector of a plate connection assembly according to a fifth embodiment of the present disclosure.

FIG. 20 is a perspective view of a box with a plate connection assembly according to a fifth embodiment of the present disclosure.

FIG. 21 is a partial schematic view of a plate connection assembly according to a fifth embodiment of the present disclosure.

FIG. 22 is a perspective view of a connector of a plate connection assembly according to a fifth embodiment of the present disclosure.

FIG. 23 is a perspective view of a connector of a plate connection assembly according to a fifth embodiment of the present disclosure from another angle.

FIG. 24 is an end view of a connector of a plate connection assembly according to a fifth embodiment of the present disclosure.

FIG. 25 is a schematic view of a box with a plate connection assembly according to a fifth embodiment of the present disclosure.

### DETAILED DESCRIPTION

Hereinafter, embodiments of the present disclosure will be described in detail, examples of which are illustrated in the accompanying drawings. The embodiments described below with reference to the drawings are exemplary and are intended to explain the present disclosure, but not to be construed as limiting the present disclosure.

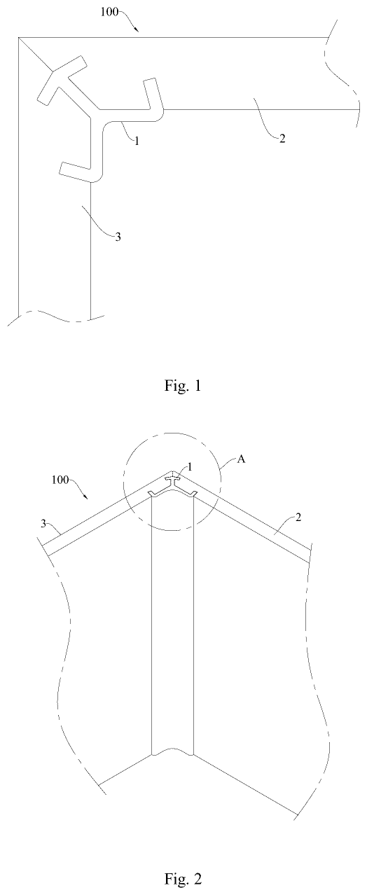

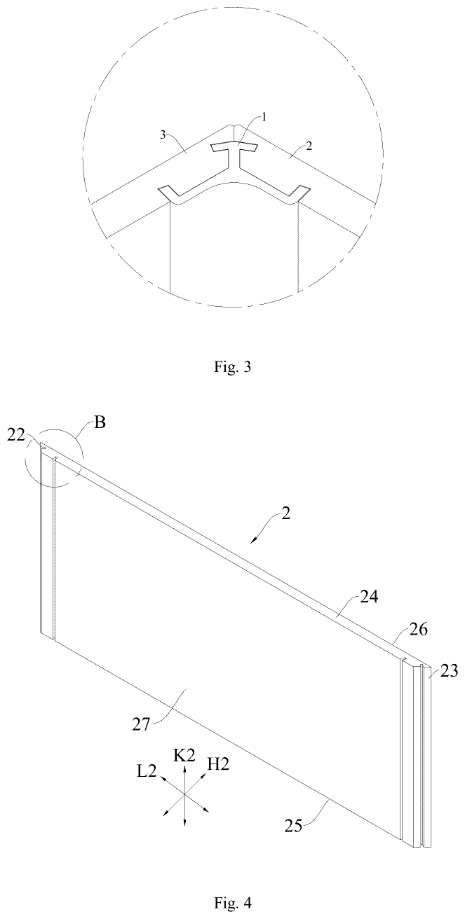

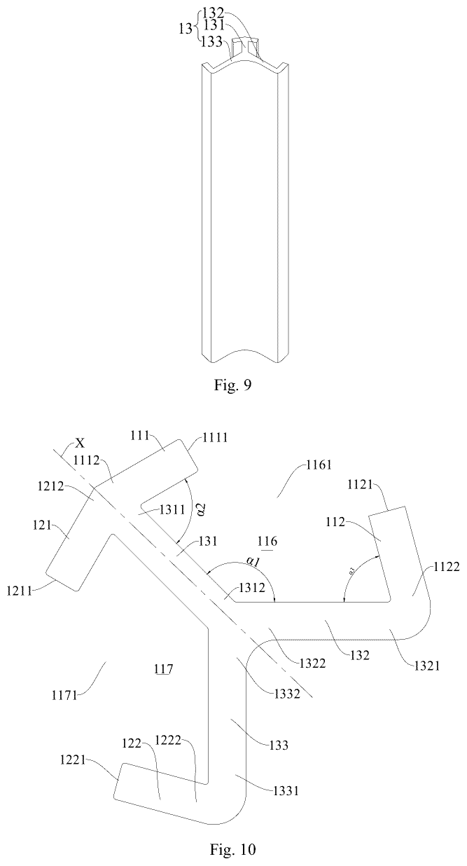

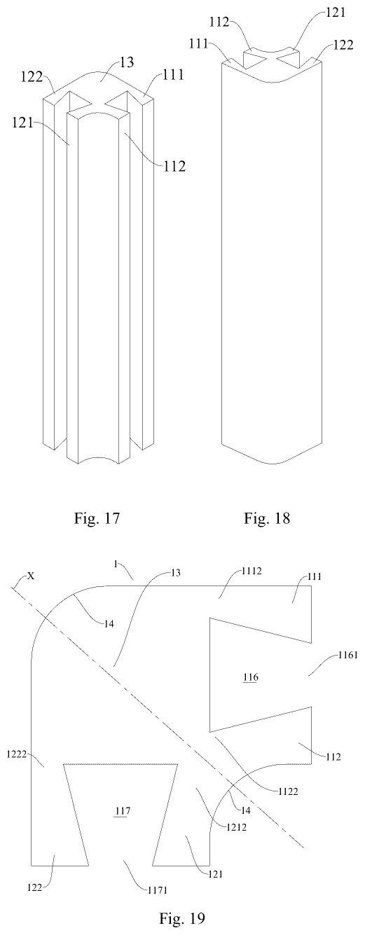

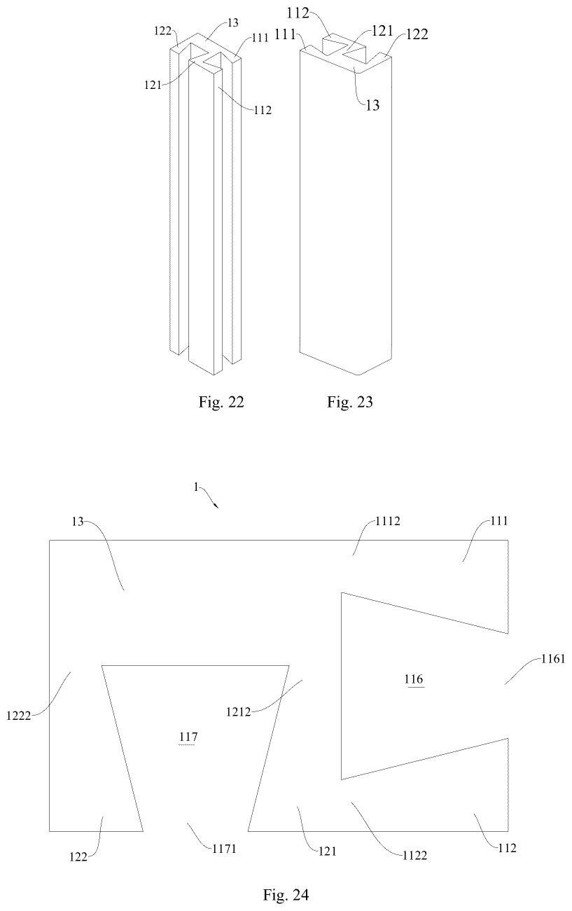

As shown in FIGS. 1-25, a plate connection assembly 100 according to an embodiment of the present disclosure includes a connector 1, a first plate 2 and a second plate 3.

The connector 1 includes a first connecting part 11 and a second connecting part 12 extending in a length direction L1 of the connector 1 (e.g., an up-down direction in FIGS. 2 and 8). The first plate 2 has a third connecting part 21 adjacent to an end of the first plate 2, and the third connecting part 21 extends in a width direction K2 of the first plate 2 (e.g., the up-down direction in FIGS. 2 and 4). The second plate 3 has a fourth connecting part 31 adjacent to an end of the second plate 3, and the fourth connecting part 31 extends in a width direction K3 of the second plate 3.

In some embodiments, the length direction of the connector 1 is the same with the width direction of the first plate 2 and the width direction of the second plate 3. The third connecting part 21 is engaged with the first connecting part 11, and the fourth connecting part 31 is engaged with the second connecting part 12, thereby connecting the first plate 2 with the second plate 3.

FIGS. 1-3 show only a first end of the first plate 2 and a first end of the second plate 3. It can be understood that a second end of the first plate 2 can be connected with another second plate 3, and a second end of the second plate 3 can be connected with another second plate 2. For example, two first plates 2 and two second plates 3 are connected in sequence, thereby forming a generally rectangular frame (i.e., peripheral side walls of the box).

The plate connection assembly 100 has an assembled state and a disassembled state. When the plate connection assembly 100 is in a disassembled state, the connector 1, the first plate 2 and the second plate 3 can be separated from each other. When the plate connection assembly 100 is in the assembled state, the third connecting part 21 is engaged with the first connecting part 11, and the fourth connecting part 31 is engaged with the second connecting part 12, thereby assembling the connector 1, the first plate 2 and the second plate 3 into a whole.

Compared with the related art in which the first plate and the second plate are directly connected through the comb-tooth tenon and the glue, in the plate connection assembly of the embodiment of the present disclosure, the first plate and the second plate are detachably connected through the connector, so that the processing difficulties of the first plate and the second plate are reduced, and the plate connection assembly has a good universality and is convenient to assemble.

The plate connection assembly can be in the disassembled state during packaging and transportation, so that the packaging volume is reduced, the transportation is convenient and the transportation cost is low. When in use, users can assemble the plate connection assembly by themselves.

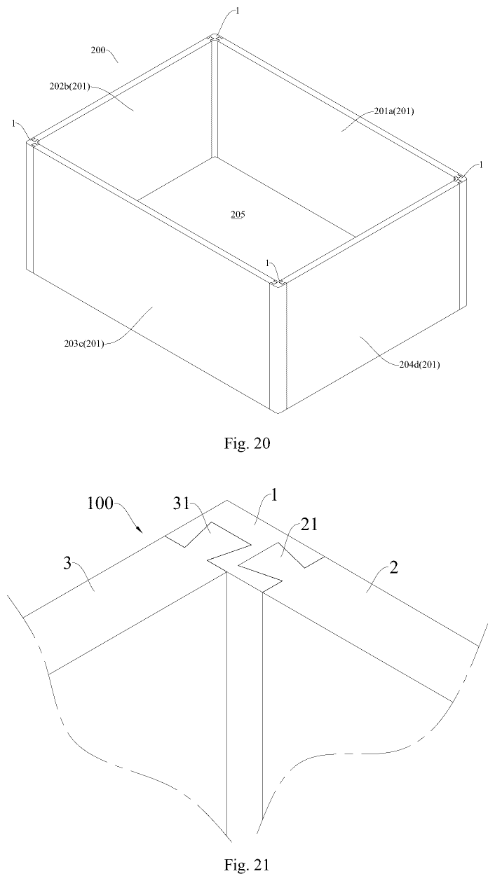

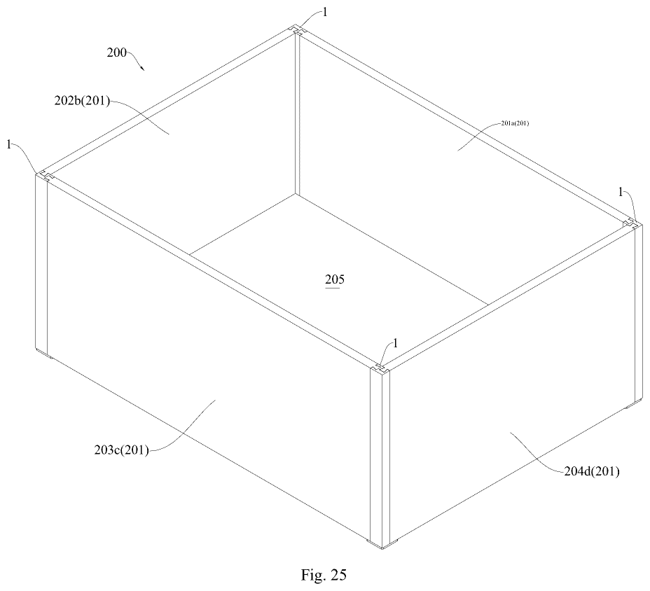

FIG. 11, FIG. 20 and FIG. 25 show a box 200 having the plate connection assembly according to the embodiment of the present disclosure. The box 200 includes a bottom plate 205, a plurality of side plates 201 and a plurality of connectors 1. The side plates 201 are connected with the bottom plate 205, adjacent side plates 201 include the first plate 2 and the second plate 3, and adjacent ends of the first plate 2 and the second plate 3 are connected with each other through the connector 1.

The connector 1 includes the first connecting part 11 and the second connecting part 12 extending in the length direction L1 of the connector 1. The first plate 2 has the third connecting part 21 adjacent to the end of the first plate 2, and the third connecting part 21 extends in the width direction K2 of the first plate 2. The second plate 3 has the fourth connecting part 31 adjacent to the end of the second plate 3, and the fourth connecting part 31 extends in the width direction K3 of the second plate 3. The third connecting part 21 is engaged with the first connecting part 11, and the fourth connecting part 31 is engaged with the second connecting part 12.

Specifically, the box 200 has four side plates 201 (i.e., two first plates 2 and two second plates 3) and one bottom plate 205. An upper surface of the box 200 is open, and adjacent ends of each side plate 201 and adjacent side plate 201 are detachably connected to each other through the connector 1. It can be understood that the box 200 may be additionally provided with a cover for covering the upper surface of the box 200.

The box 200 has a disassembled state and an assembled state. When the box 200 is in the disassembled state, the bottom plate 205, each side plate 201 and the connector 1 can be separated from each other. When the box 200 is in the assembled state, the side plate 201 is connected with the bottom plate 205. For example, an edge of the upper surface of the bottom plate 205 has a groove, and a lower side surface of the side plate 201 can be inserted into and fitted in the groove. In addition, the lower side surface of the side plate 201 can be processed to have a protrusion, and the protrusion is fitted with the groove of the bottom plate 205. It can be understood that the bottom plate 205 can be connected with the side plate in other suitable ways. The adjacent side plates 201 are connected to each other through the connector 1, in which the third connecting part 21 is engaged with the first connecting part 11, and the fourth connecting part 31 is engaged with the second connecting part 12.

In some embodiments, in the process of packaging and transportation, the box is in the disassembled state, so that the packaging volume of the box is small, the space occupied during transportation is small, and the transportation is convenient, thus reducing the cost. When assembling the box, the users can conveniently connect the side plate, the bottom plate and the connector to complete the assembling of the box by themselves. The connector is used to connect the side plates of the assembled box, so that the processing difficulties of the side plates are reduced, and different types of boxes can use the same connector, thus improving the universality and further reducing the cost.

In some embodiments, as shown in FIG. 11, the number of the side plates 201 is four. For example, the plurality of side plates 201 include a first side plate 201a, a second side plate 202b, a third side plate 203c and a fourth side plate 204d. The first side plate 201a and the third side plate 203c can be called the first plates 2, and the first side plate 201a and the third side plate 203c are arranged opposite to each other in a thickness direction H2 of the first plate 2. The second side plate 202b and the fourth side plate 204d can be called the second plates 3, and the second side plate 202b and the fourth side plate 204d are arranged opposite to each other in a thickness direction H3 of the second plate 3. It can be understood that the number of the side plates 201 is not limited to four.

As shown in FIGS. 4-7, the first plate 2 has a first end face 22 and a second end face 23 facing away from each other in its length direction L2, a first side surface 24 and a second side surface 25 facing away from each other in its width direction K2, and a first main plate surface 26 and a second main plate surface 27 facing away from each other in its thickness direction H2. In some embodiments, an included angle between the first main plate surface 26 and the first end face 22 is 30-90 degrees. More specifically, the included angle between the first main plate surface 26 and the first end face 22 is 45 degrees.

The second plate 3 has a third end face 32 and a fourth end face 33 facing away from each other in its length direction L3, a third side surface 34 and a fourth side surface 35 facing away from each other in its width direction K3, and a third main plate surface 36 and a fourth main plate surface 37 facing away from each other in its thickness direction H3. In some embodiments, an included angle between the third main plate surface 36 and the third end face 32 is 30-90 degrees. More specifically, the included angle between the third main plate surface 36 and the third end face 32 is 45 degrees.

In some embodiments, one of the first connecting part 11 and the third connecting part 21 includes a first engaging groove 116, and the other of the first connecting part 11 and the third connecting part 21 includes a first engaging protrusion 211 engaged in the first engaging groove 116. One of the second connecting part 12 and the fourth connecting part 31 includes a second engaging groove 117, and the other of the second connecting part 12 and the fourth connecting part 31 includes a second engaging protrusion 311 engaged in the second engaging groove 117. The first engaging protrusion 211 and the first engaging groove 116 extend along the length direction L1 of the connector 1 and the width direction K2 of the first plate 2, and the second engaging protrusion 311 and the second engaging groove 117 extend along the length direction L1 of the connector 1 and the width direction K3 of the second plate 3.

In the above embodiment, the connector is connected with the first plate and the second plate through the engaging protrusions and the engaging grooves, so that the manufacturing difficulties of the connector, the first plate and the second plate can be further reduced, the plate connection assembly 100 is easier to assemble, and the universality of the connector is improved. Optionally, when assembling the plate connection assembly, in order to further prevent the first engaging protrusion 211 from being disengaged from the first engaging groove 116 and the second engaging protrusion 311 from being disengaged from the second engaging groove 117, an adhesive (such as a glue) may be coated on engaging surfaces of the first engaging protrusion 211 and/or the first engaging groove 116 and engaging surfaces of the second engaging protrusion 311 and/or the second engaging groove 117. The adhesive can prevent the connector 1 from being disengaged from the first plate 2 and the second plate 3 along its length direction L1. Since the adhesive does not undertake to prevent the connector 1 from being disengaged from the first plate 2 and the second plate 3 in a direction perpendicular to the length direction L1, the requirements for the coating process of the adhesive are low.

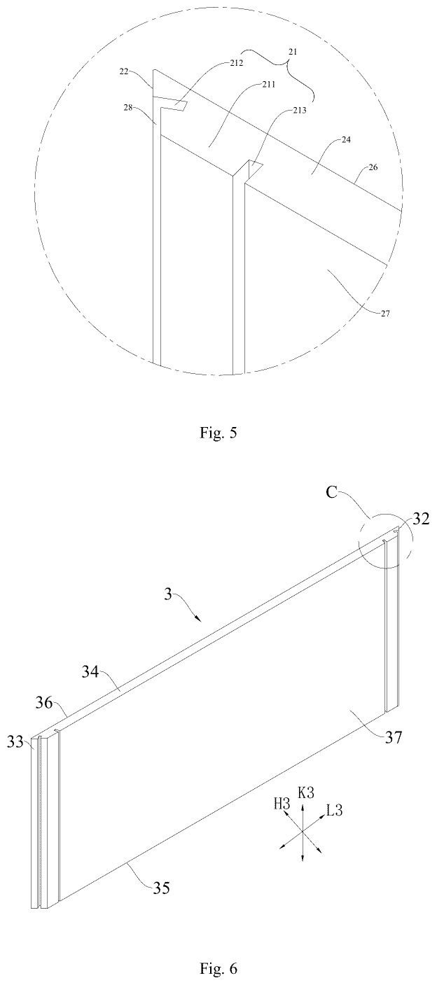

In some embodiments, as shown in FIG. 10, the first engaging groove 116 and the second engaging groove 117 are formed on the connector 1 and penetrate the connector 1 along the length direction L1 of the connector 1. As shown in FIGS. 4 and 5, a first engaging protrusion 211 is formed at the end of the first plate 2 and extends in the width direction K2 of the first plate 2, and a second engaging protrusion 311 is formed at the end of the second plate 3 and extends in the width direction K3 of the second plate 3.

In some embodiments, as shown in FIG. 10, the first connecting part 11 and the second connecting part 12 are arranged axisymmetrically. Therefore, the processing of the connector 1 is simpler, and the structure is firmer. The third connecting part and the fourth connecting part are also arranged axisymmetrically, thus further reducing the processing cost. Advantageously, each of the connector 1, the first plate 2 and the second plate 3 has an axisymmetric structure, and the first plate 2 and the second plate 3 are the same.

At least one of the first connecting part 11 and the third connecting part 21 is provided with a first convex tooth (not shown). For example, the first connecting part 11 is provided with a first convex tooth, and when the first connecting part 11 and the second connecting part 21 are engaged, the first convex tooth penetrates into the third connecting part 21. At least one of the second connecting part 12 and the fourth connecting part 31 is provided with a second convex tooth (not shown). For example, the second convex tooth is provided on the second connecting part 12, and when the second connecting part 12 and the fourth connecting part 31 are engaged, the second convex tooth penetrates into the fourth connecting part 31. Therefore, the connection strength and stability can be improved and the looseness can be avoided.

As shown in FIGS. 1-11, in a first embodiment of the present disclosure, the connector 1 includes a body portion 13, a first connecting section 111, a second connecting section 112, a third connecting section 121 and a fourth connecting section 122. The body portion 13 includes a first body section 131, a second body section 132 and a third body section 133. A first inner end 1312 of the first body section 131, a second inner end 1322 of the second body section 132 and a third inner end 1332 of the third body section 133 are connected with each other.

In some embodiments, the first connecting section 111 and the third connecting section 121 are symmetrically arranged with respect to an axis X, and the second connecting section 112 and the fourth connecting section 122 are symmetrically arranged with respect to the axis X. The second body section 132 and the third body section 133 are symmetrically arranged with respect to the axis X, and the axis X is a longitudinal central axis of the first body section 131.

A first outer end 1311 of the first body section 131 is connected with a first connecting end 1112 of the first connecting section 111 and a third connecting end 1212 of the third connecting section 121. The first connecting end 1112 of the first connecting section 111 and the third connecting end 1212 of the third connecting section 121 are located at two sides of the first body section 131, respectively. In other words, the first connecting end 1112 of the first connecting section 111 is located at a first side of the first body section 131 in a first preset direction, and the third connecting end 1212 of the third connecting section 121 is located at a second side of the first body section 131 in the first preset direction. The first preset direction is perpendicular to the axis X.

A second connecting end 1122 of the second connecting section 112 is connected with a second outer end 1321 of the second body section 132, and a fourth connecting end 1222 of the fourth connecting section 122 is connected with a third outer end 1331 of the third body section 133. In some embodiments, the second connecting section 112 and its second free end 1121 and the fourth connecting section 122 and its fourth free end 1221 are located at two sides of the body portion 13, respectively. In other words, the second connecting section 112 and its second free end 1121 are located at the first side of the body portion 13 in the first preset direction, and the fourth connecting section 122 and its fourth free end 1221 are located at the second side of the body portion 13 in the first preset direction.

In some embodiments, a first free end 1111 of the first connecting section 111 extends obliquely towards the second connecting section 112 with respect to the axis X, and the second free end 1121 of the second connecting section 112 extends obliquely towards the first connecting section 111 with respect to the axis X. A third free end 1211 of the third connecting section 121 extends obliquely towards the fourth connecting section 122 with respect to the axis X, and the fourth free end 1221 of the fourth connecting section 122 extends obliquely towards the third connecting section 121 with respect to the axis X.

The first connecting section 111, the first body section 131, the second body section 132 and the second connecting section 112 constitute the first connecting part 11 and define the first engaging groove 116 with a first engaging notch 1161, that is, the first connecting part 11 is configured as a first annular part with the first engaging notch 1161. The third connecting section 121, the first body section 131, the third body section 133 and the fourth connecting section 122 constitute the second connecting section 12 and define the second engaging groove 117 with a second engaging notch 1171, that is, the second connecting section 12 is configured as a second annular part with the second engaging notch 1171.

As shown in FIGS. 4 and 5, the third connecting part 21 includes a first fitting groove 212, a second fitting groove 213 and the first engaging protrusion 211 located between the first fitting groove 212 and the second fitting groove 213. The first connecting section 111 is engaged in the first fitting groove 212, and the second connecting section 112 is engaged in the second fitting groove 213. More specifically, the first fitting groove 212 is formed in each of the first end face 22 and the second end face 23 of the first plate 2, and the second fitting groove 213 is formed in the second main plate surface 27 of the first plate 2 and adjacent to the first fitting groove 212.

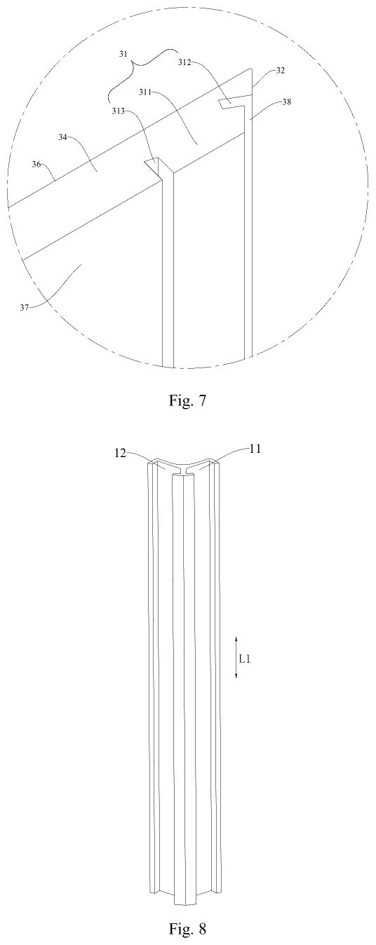

As shown in FIGS. 6 and 7, the fourth connecting part 31 includes a third fitting groove 312, a fourth fitting groove 313 and the second engaging protrusion 311 located between the third fitting groove 312 and the fourth fitting groove 313. The third connecting section 121 is engaged in the third fitting groove 312, and the fourth connecting section 122 is engaged in the fourth fitting groove 313. More specifically, the third fitting groove 312 is formed in each of the third end face 32 and the fourth end face 33 of the second plate 3, and the fourth fitting groove 313 is formed in the fourth main plate surface 37 of the second plate 3 and adjacent to the third fitting groove 312.

As shown in FIGS. 1-3, the first engaging protrusion 211 is fitted in the first engaging groove 116, and the second engaging protrusion 311 is fitted in the second engaging groove 117.

By engaging the first connecting section 111 in the first fitting groove 212 and engaging the second connecting section 112 in the second fitting groove 213, the first connecting part 11 (the connector 1) can be engaged with the first plate 2 from different directions and generate a restraining force on the first plate 2, thus improving the reliability and firmness of the connection between the connector 1 and the first plate 2. By engaging the third connecting section 121 in the third fitting groove 312 and engaging the fourth connecting section 122 in the fourth fitting groove 313, the second connecting section 12 (the connector 1) can be engaged with the second plate 3 from different directions and generate a restraining force on the second plate 3, thus improving the reliability and firmness of the connection between the connector 1 and the second plate 3. Therefore, the first plate 2 and the second plate 3 can be more firmly assembled together, thus improving the structural stability of the box 200, and also effectively reducing the gap between the first plate 2 and the second plate 3.

In some embodiments, at least one of the first connecting section 111 and the first fitting groove 212 is provided with the first convex tooth on its engaging surface, and at least one of the second connecting section 112 and the second fitting groove 213 is provided with the first convex tooth on its engaging surface. At least one of the third connecting section 121 and the third fitting groove 312 is provided with the second convex tooth on its engaging surface, and at least one of the fourth connecting section 122 and the fourth fitting groove 313 is provided with the second convex tooth on its engaging surface.

As shown in FIG. 10, an included angle α2 between the first connecting section 111 and the first body section 131 is between 15 degrees and 85 degrees, an included angle α3 between the second connecting section 112 and the second body section 132 is between 15 degrees and 85 degrees, an included angle between the third connecting section 121 and the first body section 131 is between 15 degrees and 85 degrees, and an included angle between the fourth connecting section 122 and the third body section 133 is between 15 degrees and 85 degrees.

In the above embodiment, even if there is a large machining error, the first connecting section 111 and the second connecting section 112 can well restrain the first plate 2, and the third connecting section 121 and the fourth connecting section 122 can also well restrain the second plate 3. Moreover, if the machining error is small, the gap between the connector 1 and the first plate 2 as well as the gap between the connector 1 and the second plate 3 can be further reduced.

More specifically, the included angle α2 between the first connecting section 111 and the first body section 131 is 75 degrees, the included angle α3 between the second connecting section 112 and the second body section 132 is 75 degrees, the included angle between the third connecting section 121 and the first body section 131 is 75 degrees, and the included angle between the fourth connecting section 122 and the third body section 133 is 75 degrees.

As shown in FIG. 10, an included angle α1 between the first body section 131 and the second body section 132 is between 120 degrees and 150 degrees, and an included angle between the first body section 131 and the third body section 133 is between 120 degrees and 150 degrees. Therefore, the first body section 131 and the second body section 132 are neither parallel nor perpendicular to each other, and the first body section 131 and the third body section 133 are neither parallel nor perpendicular to each other, thus further preventing the connector 1 from being disengaged from the first plate 2 and the second plate 3.

More specifically, the included angle α1 between the first body section 131 and the second body section 132 is 135 degrees, and the included angle between the first body section 131 and the third body section 133 is 135 degrees.

As shown in FIGS. 1-7, an included angle between the first main plate surface 26 and the first end face 22 is 45 degrees, and an included angle between the third main plate surface 36 and the third end face 32 is 45 degrees, so that the third end face 32 can be well fitted with the first end face 22.

The first end face 22 is provided with the first fitting groove 212, and the second end face 23 is also provided with the first fitting groove 212. The second main plate surface 27 is provided with two second fitting grooves 213, one of the two second fitting grooves 213 is adjacent to the first end face 22 in the length direction L2 of the first plate 2, and the other of the two second fitting grooves 213 is adjacent to the second end face 23 in the length direction L2 of the first plate 2. The first fitting groove 212 penetrates the first side surface 24 and the second side surface 25 along the width direction K2 of the first plate 2, and the second fitting groove 213 penetrates the first side surface 24 and the second side surface 25 along the width direction K2 of the first plate 2.

The third end face 32 is provided with the third fitting groove 312, and the fourth end face 33 is provided with the third fitting groove 312. The fourth main plate surface 37 is provided with two fourth fitting grooves 313, one of the two fourth fitting grooves 313 is adjacent to the third end face 32 in the length direction L3 of the second plate 3, and the other of the two fourth fitting grooves 313 is adjacent to the fourth end face 33 in the length direction L3 of the second plate 3. The third fitting groove 312 penetrates the third side surface 34 and the fourth side surface 35 along the width direction K3 of the second plate 3, and the fourth fitting groove 313 penetrates the third side surface 34 and the fourth side surface 35 along the width direction K3 of the second plate 3.

In some embodiments, the first end face 22 is provided with a first accommodating groove 28, and the first accommodating groove 28 in the first end face 22 communicates with the first fitting groove 212 in the first end face 22. The second end face 23 is provided with the first accommodating groove 28, and the first accommodating groove 28 in the second end face 23 communicates with the first fitting groove 212 in the second end face 23. The third end face 32 is provided with a second accommodating groove 38, and the second accommodating groove 38 in the third end face 32 communicates with the third fitting groove 312 in the third end face 32. The fourth end face 33 is provided with the second accommodating groove 38, and the second accommodating groove 38 in the fourth end face 33 communicates with the third fitting groove 312 in the fourth end face 33.

A part of the first body section 131 is accommodated in the first accommodating groove 28, and another part of the first body section 131 is accommodated in the second accommodating groove 38. The second body section 132 can be fitted with one of the second main plate surface 27 and the fourth main plate surface 37, and the third body section 133 can be fitted with the other of the second main plate surface 27 and the fourth main plate surface 37.

FIG. 11 shows the box 200 with the plate connection assembly 100 shown in FIGS. 1-3, and the plate connection assembly 100 has the connector 1 shown in FIG. 10.

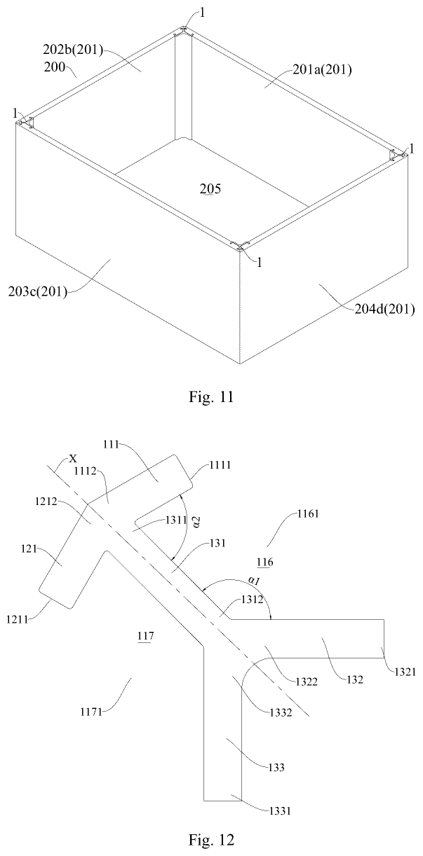

As shown in FIG. 12, a connector 1 of a second embodiment of the present disclosure includes a body portion 13, a first connecting section 111 and a third connecting section 121. The body portion 13 includes a first body section 131, a second body section 132 and a third body section 133. A first inner end 1312 of the first body section 131, a second inner end 1322 of the second body section 132 and a third inner end 1332 of the third body section 133 are connected with each other.

The embodiment shown in FIG. 12 is substantively the same with the embodiment shown in FIG. 10, except that the connector 1 does not have the second connecting section 112 and the fourth connecting section 122.

The first connecting section 111 and the third connecting section 121 are symmetrically arranged with respect to the axis X. The second body section 132 and the third body section 133 are symmetrically arranged with respect to the axis X. A first connecting end 1112 of the first connecting section 111 and a third connecting end 1212 of the third connecting section 121 are connected with a first outer end 1311 of the first body section 131, respectively. The first connecting end 1112 of the first connecting section 111 and the third connecting end 1212 of the third connecting section 121 are located at two sides of the first body section 131, respectively.

The first connecting section 111, the first body section 131 and the second body section 132 constitute the first connecting part 11 and define the first engaging groove 116 with a first engaging notch 1161. The third connecting section 121, the first body section 131 and the third body section 133 constitute the second connecting section 12 and define the second engaging groove 117 with a second engaging notch 1171.

In some embodiments, the first end face 22 is provided with a first accommodating groove 28, and the first accommodating groove 28 in the first end face 22 communicates with a first fitting groove 212 in the first end face 22. The second end face 23 is also provided with the first accommodating groove 28, and the first accommodating groove 28 in the second end face 23 communicates with the first fitting groove 212 in the second end face 23. The third end face 32 is provided with a second accommodating groove 38, and the second accommodating groove 38 in the third end face 32 communicates with a third fitting groove 312 in the third end face 32. The fourth end face 33 is also provided with the second accommodating groove 38, and the second accommodating groove 38 in the fourth end face 33 communicates with a third fitting groove 312 in the fourth end face 33.

A part of the first body section 131 is accommodated in the first accommodating groove 28, and another part of the first body section 131 is accommodated in the second accommodating groove 38. The second body section 132 can be fitted with one of the second main plate surface 27 and the fourth main plate surface 37, and the third body section 133 can be fitted with the other of the second main plate surface 27 and the fourth main plate surface 37.

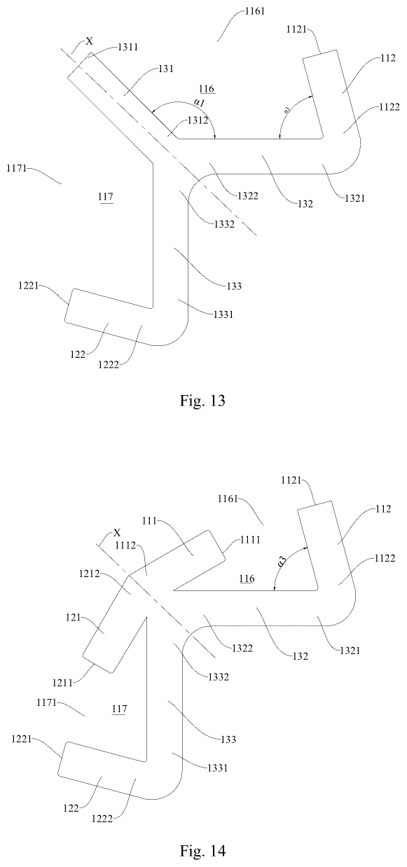

As shown in FIG. 13, a connector 1 of a third embodiment of the present disclosure includes a body portion 13, a second connecting section 112 and a fourth connecting section 122. The body portion 13 includes a first body section 131, a second body section 132 and a third body section 133. A first inner end 1312 of the first body section 131, a second inner end 1322 of the second body section 132 and a third inner end 1332 of the third body section 133 are connected with each other.

The embodiment shown in FIG. 13 is substantively the same with the embodiment shown in FIG. 10, except that the connector 1 does not have the first connecting section 111 and the third connecting section 121.

A second connecting end 1122 of the second connecting section 112 is connected with a second outer end 1321 of the second body section 132, and a fourth connecting end 1222 of the fourth connecting section 122 is connected with a third outer end 1331 of the third body section 133. In some embodiments, the second connecting section 112 and its second free end 1121 and the fourth connecting section 122 and its fourth free end 1221 are located at two sides of the body portion 13, respectively.

The first body section 131, the second body section 132 and the second connecting section 112 constitute the first connecting part 11 and define the first engaging groove 116 with a first engaging notch 1161, that is, the first connecting part 11 is configured as a first annular part with the first engaging notch 1161. The first body section 131, the third body section 133 and the fourth connecting section 122 constitute the second connecting part 12 and define the second engaging groove 117 with a second engaging notch 1171, that is, the second connecting part 12 is configured as a second annular part with the second engaging notch 1171.

As shown in FIG. 14, a connector 1 of a fourth embodiment of the present disclosure includes a body portion 13, a first connecting section 111, a second connecting section 112, a third connecting section 121 and a fourth connecting section 122. The body portion 13 includes a second body section 132 and a third body section 133. A second inner end 1322 of the second body section 132 and a third inner end 1332 of the third body section 133 are connected with each other.

The embodiment shown in FIG. 14 is substantively the same with the embodiment shown in FIG. 10, except that the body portion 13 does not have the first body section 131.

A first connecting end 1112 of the first connecting section 111, a third connecting end 1212 of the third connecting section 121, a second inner end 1322 of the second body section 132 and a third inner end 1332 of the third body section 133 are connected with each other. The first connecting end 1112 of the first connecting section 111 and the third connecting end 1212 of the third connecting section 121 are located at two sides of the second inner end 1322 of the second body section 132 (the third inner end 1332 of the third body section 133), respectively.

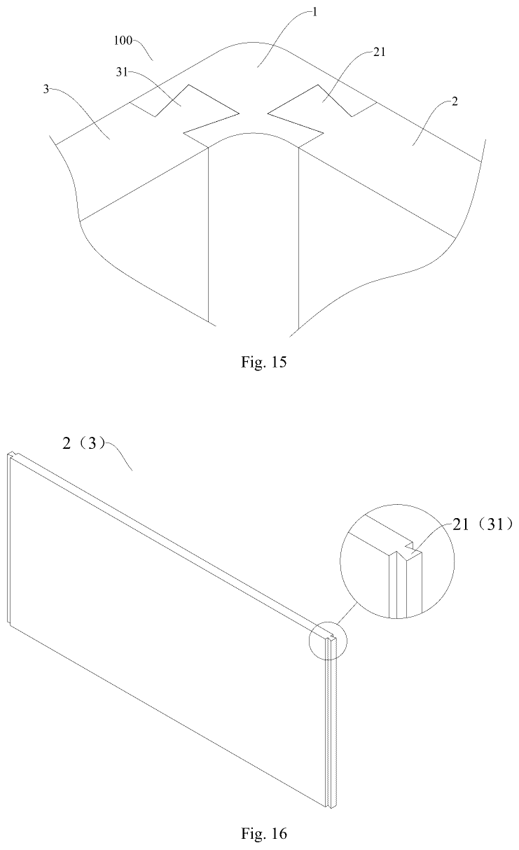

As shown in FIGS. 15-25, a connector 1 of a fifth embodiment of the present disclosure includes a first connecting section 111, a second connecting section 112, a third connecting section 121, a fourth connecting section 122 and a generally rectangular body portion 13. A first connecting end 1112 of the first connecting section 111 and a second connecting end 1122 of the second connecting section 112 are connected with the body portion 13 and spaced apart from each other to form the first engaging groove 116 with a first engaging notch 1161. A third connecting end 1212 of the third connecting section 121 and a fourth connecting end 1222 of the fourth connecting section 122 are connected with the body portion 13 and spaced apart from each other to form the second engaging groove 117 with a second engaging notch 1171.

The first engaging groove 116 and the second engaging groove 117 are dovetail-shaped, the first engaging protrusion 211 is formed on each of the end faces (the first end face 22 and the second end face 23) of the first plate 2, and the first engaging protrusion 211 is configured to be dovetail-shaped so as to be adapted to the first engaging groove 116. The second engaging protrusion 311 is formed on each of the end faces (the third end face 32 and the fourth end face 33) of the second plate 3, and the second engaging protrusion 311 is configured to be dovetail-shaped so as to be adapted to the second engaging groove 117. The first engaging protrusion 211 is engaged in the first engaging groove 116, and the second engaging protrusion 311 is engaged in the second engaging groove 117.

In some embodiments, as shown in FIG. 19, the connector 1 has a structure symmetrical with respect to the axis X. In an opening direction of the first engaging notch 1161, the first engaging groove 116 and the second engaging groove 117 are staggered, and in an opening direction of the second engaging notch 1171, the first engaging groove 116 and the second engaging groove 117 are staggered.

In some embodiments, as shown in FIG. 24, in the opening direction of the first engaging notch 1161, the first engaging groove 116 and the second engaging groove 117 are partially overlapped, and in the opening direction of the second engaging notch 1171, the first engaging groove 116 and the second engaging groove 117 are staggered.

As shown in FIG. 15, FIG. 20, FIG. 21 and FIG. 25, the included angle between the first main plate surface 26 and the first end face 22 is 90 degrees, the included angle between the third main plate surface 36 and the third end face 32 is 90 degrees, and the included angle between the first end face 22 and the third end face 32 is 90 degrees. The first end face 22 can be fitted with one end face of the connector 1 and the third end face 32 can be fitted with the other end face of the connector 1.

FIG. 20 shows a box 200 having the plate connection assembly 100 shown in FIG. 15, and the plate connection assembly 100 has the connector 1 shown in FIG. 19.

FIG. 25 shows a box 200 having the plate connection assembly 100 shown in FIG. 21, and the plate connection assembly 100 has the connector 1 shown in FIG. 24.

In some embodiments, the plate connection assembly includes a connector 1, a first plate 2 and a second plate 3. An end of the first plate 2 forms a third connecting part 21, and an end of the second plate 3 forms a fourth connecting part 31. The connector 1 has a first connecting part 11 and a second connecting part 12, the first connecting part 11 and the third connecting part 21 are fitted with each other to prevent the first plate 2 from being disengaged from the connector 1, and the second connecting part 12 and the fourth connecting part 31 are fitted with each other to prevent the second plate 3 from being disengaged from the connector 1. The first connecting part 11, the second connecting part 12, the third connecting part 21 and the fourth connecting part 31 all extend in a height direction (of the box 200), and the first plate 2 and the second plate 3 are connected by the connector 1 detachable in the height direction.

A horizontal anti-disengagement structure is formed between the connector 1 and the first plate 2 and also between the connector 1 and the second plate 3, so that they can be packaged in parts and assembled by the users themselves, thereby reducing the packaging and transportation cost. The disengagement mainly refers to the disengagement in the horizontal direction.

The third connecting part 21 and the fourth connecting part 31 may be the same, and the first connecting part 11 and the second connecting part 12 may be the same.

The third connecting part 21 may be an isosceles trapezoid part (a first engaging protrusion 211), and the first connecting part 11 is provided with a first engaging groove 116 that is fitted with the isosceles trapezoid part. The included angle between the first end face 22 and the first main plate surface 26 of the first plate 2 is 90 degrees.

The connector 1 can be an axisymmetric connector, the horizontal section of the connector 1 is generally L-shaped, and an inner side and an outer side of the connector 1 have a rounded corner 14. Alternatively, the horizontal section of the connector 1 is generally rectangular, and only the outer side of the connector 1 has the rounded corner 14.

The first connecting part 11 of the connector 1 includes a first connecting section 111, a first body section 131 and a second body section 132 which are connected in sequence. The first connecting section 111 is embedded in the first plate 2, and the first plate 2 is provided with a first fitting groove 212 which is fitted with the first connecting section 111. The first body section 131 and the second body section 132 are fitted with the first plate 2.

The first connecting part 11 includes the first connecting section 111, the first body section 131 and the second body section 132, and the angle α1 between the first body section 131 and the second body section 132 is 135 degrees.

The first connecting section 111 is embedded in the first end face 22 of the first plate 2, and the angle α2 between the first connecting section 111 and the first body section 131 is between 50 degrees and 130 degrees. Alternatively, the second connecting section 112 is embedded in the second main plate surface 27 of the first plate 2, and the angle α3 between the second connecting section 112 and the second body section 132 is between 15 degrees and 85 degrees.

The first connecting section 111 is embedded in the first end face 22 of the first plate 2, and the first connecting part 11 further includes a second connecting section 112 connected with the second body section 132 and configured to be embedded in the second main plate surface 27 of the first plate 2. The angle α1 between the first body section 131 and the second body section 132 is 135 degrees, the angle α2 between the first connecting section 111 and the first body section 131 is between 15 degrees and 85 degrees, and the angle α3 between the second body section 132 and the second connecting section 112 is between 15 degrees and 85 degrees.

The first end face 22 of the first plate 2 is provided with a trapezoidal first engaging groove 116 and forms a third connecting part 21, and the connector 1 has a first engaging protrusion 211 that is fitted with the trapezoidal first engaging groove 116. The third end face 32 of the second plate 3 is provided with a trapezoidal second engaging groove 117 and forms a fourth connecting part 31. The connector 1 has a second engaging protrusion 311 that is fitted with the trapezoidal second engaging groove 117. The first engaging protrusion 211 and the second engaging protrusion 311 are connected.

The first end face 22 of the first plate 2 is fitted with the third end face 32 of the second plate 3. The included angle between the first end face 22 of the first plate 2 and the first main plate surface 26 of the first plate 2 is 45 degrees, and the included angle between the third end face 32 of the second plate 3 and the third main plate surface 36 of the second plate 3 is 45 degrees.

Referring to FIGS. 15 to 20, in some embodiments, the box 200 includes four side plates 201 and four connectors 1, the four side plates 201 enclose a rectangle, and the four connectors 1 are the same. The plate connection assembly 100 includes the first plate 2 and the second plate 3. The first plate 2 and the second plate 3 differ only in length. The third connecting part 21 and the fourth connecting part 31 are the same, and the first connecting part 11 and the second connecting part 12 are the same.

In some embodiments, the third connecting part 21 is an isosceles trapezoid part (a first engaging protrusion 211), and the first connecting part 11 is provided with a first engaging groove 116 which is fitted with the isosceles trapezoid part. An outer end of the isosceles trapezoid part is larger than an inner end of the isosceles trapezoid part, thus preventing the horizontal disengagement of the first plate 2 and the connector 1. In other embodiments, the isosceles trapezoid part and the first engaging groove 116 may also have other shapes with the anti-disengagement function.

In some embodiments, the connector 1 is an axisymmetric connector. The connector 1 can be a metal piece, and the connector 1 is an integral piece.

In some embodiments, two outer side surfaces of the connector 1 are perpendicular to each other, one of the two outer side surfaces is flush with the first main plate surface 26 of the first plate 2 and the other of the two outer side surfaces is flush with the third main plate surface 36 of the second plate 3. The joint of the two outer side surfaces has a rounded corner 14. Two inner side surfaces of the connector 1 are perpendicular to each other, one of the two inner side surfaces is flush with the second main plate surface 27 of the first plate 2 and the other of the two inner side surfaces is flush with the fourth main plate surface 37 of the second plate 3. The joint of the two inner side surfaces have a rounded corner 14. Two end faces of the connector 1 are fitted with the first end face 22 of the first plate 2 and the third end face 32 of the second plate 3, respectively.

During assembling, the connector 1 can be fixed and the first plate 2 and the second plate 3 can be inserted into the connector 1 along the height direction; or, the first plate 2 and the second plate 3 can be fixed and the connector 1 can be connected with the first plate 2 and the second plate 3.

In some embodiments, after the four side plates 201 and the four connectors 1 are assembled, the glue can be applied to the joints to prevent the connectors 1 from falling off relative to the side plates 201 in the height direction.

Referring to FIG. 21 to FIG. 25, the horizontal section of the connector 1 is generally rectangular, and only the outer side of the connector 1 is has a rounded corner 14.

Referring to FIGS. 1 to 11, the box 200 includes four side plates 201 and four connectors 1. The four side plates 201 enclose a rectangle, and adjacent side plates (the first plate and the second plate) only differ in length. The connector 1 is an axisymmetric connector. The four connectors 1 are all the same.

In some embodiments, the first end face 22 of the first plate 2 is provided with a first fitting groove 212 and forms the third connecting part 21, and the connector 1 has a first connecting section 111 that is fitted with the first fitting groove 212.

The first end face 22 of the first plate 2 is also provided with a first accommodating groove 28 communicating with the first fitting groove 212. The connector 1 has a first body section 131 fitted with the first accommodating groove 28, and the second main plate surface 27 of the first plate 2 is also provided with a second fitting groove 213 to form the third connecting part 21. The connector 1 has a second connecting section 112 that is fitted with the second fitting groove 213, and further includes a second body section 132 integrated with the first connecting section 111, the first body section 131 and the second connecting section 112, and the second body section 132 is fitted with the second main plate surface 27 of the first plate 2.

The included angle between the first end face 22 of the first plate 2 and the first main plate surface 26 of the first plate 2 is 45 degrees, and the angle α1 between the first body section 131 and the second body section 132 is 135 degrees, for the 45-degree splicing of the second plate 3 and the first plate 2.

In some embodiments, the connector 1 is not exposed to the outer side surface of the box 200, so that the spliced product is more visually consistent.

In other embodiments, the connector 1 can only have the first connecting section 111, the first body section 131 and the second body section 132, without the second connecting section 112, or only have the first body section 131, the second body section 132 and the second connecting section 112, without the first connecting section 111, and the relevant angles can also be adjusted accordingly. Through experiments, the connector 1 can obtain a good connection performance without the first connecting section 111 or the second connecting section 112, and also, can reduce the material cost and the processing cost, and make the assembling easier.

In some embodiments, the connector 1 includes a first connecting part 11 and a second connecting part 12, and the first connecting part 11 and the second connecting part 12 are integrated. The first connecting part 11 is configured to be connected with the first plate 2 in the height direction, and the second connecting part 12 is configured to be connected with the second plate 3 in the height direction. The first connecting part 11 includes a first connecting section 111, a first body section 131 and a second body section 132 which are connected in sequence, the first connecting section 111 is configured to be embedded in the first plate 2 and prevent the first connecting section 111 from being disengaged from the first plate 2, and the first body section 131 and the second body section 132 are configured to be surface-fitted with and/or embedded in the first plate 2.

Compared with the existing storage box whose side plates are connected by the comb-tooth tenon, which can be assembled by the users themselves, the side plate 201 and the connector 1 can be packaged separately, and the packaging and transportation cost can be reduced. The disengagement mainly refers to the disengagement in the horizontal direction.

The first connecting part 11 and the second connecting part 12 are bilaterally symmetrical. The first connecting section 111 is embedded in the first end face 22 of the first plate 2, and the first connecting part 11 further includes a second connecting section 112 connected with the second body section 132 and configured to be embedded in the second main plate surface 27 of the first plate 2. The first connecting section 111, the first body section 131, the second body section 132 and the second connecting section 112 are all straight sections.

The angle α1 between the first body section 131 and the second body section 132 is between 120 degrees and 150 degrees, the angle α2 between the first connecting section 111 and the first body section 131 is between 15 degrees and 85 degrees, and the angle α3 between the second body section 132 and the second connecting section 112 is between 15 degrees and 85 degrees. The angle α1 between the first body section 131 and the second body section 132 is 135 degrees. The length of the second connecting section 112 is equal to the length of the first connecting section 111.

The angle α1 between the first body section 131 and the second body section 132 is 135 degrees. When the first connecting part 11 includes the first connecting section 111, the first body section 131 and the second body section 132 and the first connecting section 111 is embedded in the first end face 22 of the first plate 2, the angle α2 between the first connecting section 111 and the first body section 131 is between 50 degrees and 130 degrees.

In some embodiments, the connector 1 can be a metal piece or a plastic piece, and the connector 1 is an integral piece, with a uniform cross section and a uniform thickness everywhere.

In some embodiments, the first connecting part 11 and the second connecting part 12 are both in an open ring shape, the first connecting part 11 can restrain the first plate 2 and the second connecting part 12 can restrain the second plate 3, so as to avoid or reduce the gap between the first plate 2 and the second plate 3.

In some embodiments, the first connecting part includes a first section 31, a second section 32, a third section 33 and a fourth section 34 which are connected in sequence. The second section 32 is fitted with the end face of the first plate 2, and the third section 33 is fitted with the inner side surface of the first plate 2. The fourth section 34 is embedded in the inner side surface of the first plate 2. The first section 31, the second section 32, the third section 33 and the fourth section 34 are all straight sections.

In some embodiments, the angle α1 between the first body section 131 and the second body section 132 is 135 degrees, and the first plate 2 and the second plate 3 are spliced at 45 degrees. The included angle between the first end face 22 of the first plate 2 and the first main plate surface 26 of the first plate 2 is 45 degrees, and the included angle between the third end face 32 of the second plate 2 and the third main plate surface 36 of the second plate 3 is 45 degrees.

In other embodiments, when the first plate 2 and the second plate 3 are spliced at other angles, the angle between the first body section 131 and the second body section 132 can also be adjusted accordingly.

In some embodiments, the length of the second connecting section 112 is greater than that of the first connecting section 111. Since the first connecting section 111 is embedded in the first end face 22 of the first plate 2 and the second connecting section 112 is embedded in the second main plate surface 27 of the first plate 2, the first connecting section 111 is arranged to be relatively short to prevent the first connecting section 111 from being too close to the first main plate surface 26 of the first plate 2. In other embodiments, the length of the second connecting section 112 may be equal to or smaller than that of the first connecting section 111.

Referring to FIG. 1 to FIG. 11, the side plate 201 includes two first plates 2 and two second plates 3, the two first plates 2 are the same, the two second plates 3 are the same, and the first plate 2 and the second plate 3 differ only in length.

In some embodiments, the angle between the first end face 22 of the first plate 2 and the first main plate surface 26 of the first plate 2 is 45 degrees, and the angle between the third end face 32 of the second plate 3 and the third main plate surface 36 of the second plate 3 is 45 degrees. A first fitting groove 212 and a first accommodating groove 28 communicating with each other are formed at the first end face 22 of the first plate 2, and a second fitting groove 213 is also formed at the second main plate surface 27 of the first plate 2. The first connecting section 111 of the connector 1 is located in the first fitting groove 212, the first body section 131 is located in the first accommodating groove 28, and the second body section 132 is fitted with the second main plate surface 27 between the first accommodating groove 28 and the second fitting groove 213 of the first plate 2.

In some embodiments, the connector 1 will not be exposed from the first plate 2 or the second plate 3, and the connector 1 cannot be observed from the outer side surface after the side plates 201 are spliced, which is more beautiful.

In some embodiments, the connector 1 has a first connecting part 11 and a second connecting part 12 which are connected into a whole, and the first connecting part 11 and the second connecting part 12 are spliced with the first plate 2 and the second plate 3 in the height direction, respectively. Compared with the existing wooden storage box whose wooden plates are connected by the comb-tooth tenon, which can be assembled by the users themselves, the side plate 201 and the connector 1 can be packaged separately, and thus the packaging and transportation cost can be reduced. The first connecting part 11 and the second connecting part 12 are in an open ring shape, which can generate a restraining force on the first plate 2 and the second plate 3, so as to avoid or reduce the gap between the first plate 2 and the second plate 3. The first connecting part 11 includes a first connecting section 111, a first body section 131, a second body section 132 and a second connecting section 112, and the angle α1 between the first body section 131 and the second body section 132 is 135 degrees, for splicing the first plate 2 with the second plate 3 at 45 degrees. The angle α2 between the first connecting section 111 and the first body section 131 is limited, and the angle α3 between the second connecting section 112 and the second body section 132 is limited. The first connecting section 111 and the second connecting section 112 can restrain the first plate 2 (the second plate 3), thus avoiding or reducing the gap between the first plate 2 and the second plate 3, which is firm and reliable.

Referring to FIG. 12, in some embodiments, the connector 1 only includes the first connecting section 111, the first body section 131, and the second body section 132, without the second connecting section 112. Through experiments, it is found that the connector 1 can also connect the first plate 2 and the second plate 3 well without the second connecting section 112, although the performance is slightly worse than that with the second connecting section 112.

In some embodiments, the connector 1 omits the second connecting section 112, which can reduce the material cost and the processing cost, and also make the assembling easier.

In some embodiments, the angle α1 of the first body section 131 and the second body section 132 is 135 degrees. The first connecting section 111 is neither parallel nor perpendicular to the second body section 132, thus playing the role of preventing the horizontal disengagement. More specifically, the angle α2 between the first connecting section 111 and the first body section 131 is between 50 degrees and 130 degrees.

In other embodiments, the angle α2 between the first connecting section 111 and the first body section 131 can also be less than 45 degrees, such as between 15 degrees and 40 degrees.

Referring to FIG. 13, in some embodiments, the angle α1 between the first body section 131 and the second body section 132 is 135 degrees, the first connecting part 11 includes the first body section 131, the second body section 132 and the second connecting section 112, and the second connecting section 112 is embedded in the second main plate surface 27 of the first plate 2, and the angle α3 between the second connecting section 112 and the second body section 132 is between 15 degrees and 85 degrees. The connector 1 of this embodiment can also achieve a good connection effect.

Referring to FIG. 14, in some embodiments, the first connecting part 11 includes the first connecting section 111, the second body section 132 and the second connecting section 112, and the second connecting section 112 is also embedded in the first plate 2 to prevent the second connecting section 112 from being disengaged from the first plate 2. The angles between the first connecting section 111, the second body section 132 and the second connecting section 112 can be set accordingly as required.

In the description of the present disclosure, it should be understood that, terms such as “central”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “anticlockwise”, “axial”, “radial”, “circumferential” should be construed to refer to the orientation or position as shown in the drawings, and these relative terms are only for convenience and simplification of description rather than indicating or implying that the referred device or element must have a particular orientation, and be constructed and operated in a particular orientation, and therefore should not be construed as limiting the present disclosure.

In addition, terms such as “first” and “second” are used herein for purposes of description and are not intended to indicate or imply relative importance or significance or implicitly indicate the number of technical features indicated. Therefore, the feature defined as “first” or “second” may explicitly or implicitly include at least one such feature. In the description of the present disclosure, “a plurality of” means at least two, such as two, three, etc., unless specified or limited otherwise.

In the present disclosure, unless specified or limited otherwise, the terms “mount”, “couple”, “connect” and “fix” should be broadly understood, for example, they may refer to the fixed connection, the detachable connection or the integration; they may refer to the mechanical connection, the electrical connection or the mutual communication; they may refer to the direct connection or the indirect connection through the intermediate medium, and they may refer to the internal communication of two elements or the interaction between two elements, unless specified otherwise. For those ordinary skilled in the art, the specific meanings of the above terms in the present disclosure may be understood according to specific situations.

In the present disclosure, unless specified or limited otherwise, a structure in which a first feature is “on” or “below” a second feature may include an embodiment in which the first feature directly contacts the second feature, and may also include an embodiment in which the first feature indirectly contacts the second feature through an intermediate medium. Furthermore, a first feature “on”, “above”, or “on top of” a second feature may include an embodiment in which the first feature is right “on”, “above”, or “on top of” the second feature, and may also include an embodiment in which the first feature is obliquely “on”, “above”, or “on top of” the second feature, or just means that the first feature is at a height higher than that of the second feature. A first feature “beneath”, “below”, or “on bottom of” a second feature may include an embodiment in which the first feature is right “beneath”, “below”, or “on bottom of” the second feature, and may also include an embodiment in which the first feature is obliquely “beneath”, “below”, or “on bottom of” the second feature, or just means that the first feature is at a height lower than that of the second feature.

In the present disclosure, the terms “one embodiment”, “some embodiments”, “examples”, “specific examples” or “some examples” etc. mean that the specific features, structures, materials or characteristics described in connection with this embodiment or example are included in at least one embodiment or example of the present disclosure. In this specification, the schematic expressions of the above terms are not necessarily aimed at the same embodiment or example. Moreover, the specific features, structures, materials or characteristics described may be combined in any one or more embodiments or examples in a suitable manner. In addition, those skilled in the art can combine and group different embodiments or examples and features of different embodiments or examples described in this specification without mutual contradiction.

Although the above embodiments have been shown and described, it would be understood that the above embodiments are illustrative and cannot be construed to limit the present disclosure, and changes, modifications, alternatives, and variants of the above embodiments made by those ordinary skilled in the art fall within the scope of protection of the present disclosure.

1. A plate connection assembly, comprising:
a connector comprising a first connecting part and a second connecting part extending along a length direction of the connector; and
a first plate and a second plate, wherein the first plate has a third connecting part adjacent to an end of the first plate and extending in a width direction of the first plate, and the second plate has a fourth connecting part adjacent to an end of the second plate and extending in a width direction of the second plate, and the third connecting part is engaged with the first connecting part, and the fourth connecting part is engaged with the second connecting part.

2. The plate connection assembly according to claim 1, wherein,
one of the first connecting part and the third connecting part comprises a first engaging groove, and the other of the first connecting part and the third connecting part comprises a first engaging protrusion engaged in the first engaging groove; and
one of the second connecting part and the fourth connecting part comprises a second engaging groove, and the other of the second connecting part and the fourth connecting part comprises a second engaging protrusion engaged in the second engaging groove.

3. The plate connection assembly according to claim 2, wherein,
the connector comprises a body portion, a first connecting section, a second connecting section, a third connecting section and a fourth connecting section;
the body portion comprises a first body section, a second body section and a third body section, wherein a first inner end of the first body section, a second inner end of the second body section and a third inner end of the third body section are connected with each other;
a first connection end of the first connecting section and a third connection end of the third connecting section are respectively connected with a first outer end of the first body section and located on both sides of the first body section, a second connection end of the second connecting section is connected with a second outer end of the second body section, and a fourth connection end of the fourth connecting section is connected with a third outer end of the third body section;
the first connecting section, the first body section, the second body section and the second connecting section constitute the first connecting part and define the first engaging groove with a first engaging notch; and
the third connecting section, the first body section, the third body section and the fourth connecting section constitute the second connecting part and define the second engaging groove with a second engaging notch.

4. The plate connection assembly according to claim 3, wherein an included angle between the first body section and the second body section is between 120 degrees and 150 degrees, an included angle between the first connecting section and the first body section is between 15 degrees and 85 degrees, and an included angle between the second connecting section and the second body section is between 15 degrees and 85 degrees.

5. The plate connection assembly according to claim 3, wherein the third connecting part comprises a first fitting groove, a second fitting groove and a first engaging protrusion located between the first fitting groove and the second fitting groove, wherein the first connecting section is engaged in the first fitting groove and the second connecting section is engaged in the second fitting groove; and
the fourth connecting part comprises a third fitting groove, a fourth fitting groove and a second engaging protrusion located between the third fitting groove and the fourth fitting groove, wherein the third connecting section is engaged in the third fitting groove and the fourth connecting section is engaged in the fourth fitting groove.

6. The plate connection assembly according to claim 2, wherein,
the connector comprises a body portion, a first connecting section and a third connecting section;
the body portion comprises a first body section, a second body section and a third body section, wherein a first inner end of the first body section, a second inner end of the second body section and a third inner end of the third body section are connected with each other;
a first connecting end of the first connecting section and a third connecting end of the third connecting section are respectively connected with a first outer end of the first body section and located at both sides of the first body section;
the first connecting section, the first body section and the second body section constitute the first connecting part and define the first engaging groove with a first engaging notch; and
the third connecting section, the first body section and the third body section constitute the second connecting part and define the second engaging groove with a second engaging notch.

7. The plate connection assembly according to claim 2, wherein,
the connector comprises a body portion, a second connecting section and a fourth connecting section;
the body portion comprises a first body section, a second body section and a third body section, wherein a first inner end of the first body section, a second inner end of the second body section and a third inner end of the third body section are connected with each other;
a second connecting end of the second connecting section is connected with a second outer end of the second body section, and a fourth connecting end of the fourth connecting section is connected with a third outer end of the third body section;
the first body section, the second body section and the second connecting section constitute the first connecting part and define the first engaging groove with a first engaging notch; and
the first body section, the third body section and the fourth connecting section constitute the second connecting part and define the second engaging groove with a second engaging notch.

8. The plate connection assembly according to claim 2, wherein,
the connector comprises a body portion, a first connecting section, a second connecting section, a third connecting section and a fourth connecting section;
the body portion comprises a second body section and a third body section, a second inner end of the second body section and a third inner end of the third body section are connected with each other;
a first connecting end of the first connecting section, a third connecting end of the third connecting section, the second inner end of the second body section and the third inner end of the third body section are connected with each other, a second connecting end of the second connecting section is connected with a second outer end of the second body section, and a fourth connecting end of the fourth connecting section is connected with a third outer end of the third body section;
the first connecting section, the second body section and the second connecting section constitute the first connecting part and define the first engaging groove with a first engaging notch; and
the third connecting section, the third body section and the fourth connecting section constitute the second connecting part and define the second engaging groove with a second engaging notch.

9. The plate connection assembly according to claim 2, wherein,
the connector comprises a first connecting section, a second connecting section, a third connecting section, a fourth connecting section and a generally rectangular body portion;
a first connecting end of the first connecting section and a second connecting end of the second connecting section are connected with the body portion and spaced apart from each other to form the first engaging groove with a first engaging notch;
a third connection end of the third connecting section and a fourth connection end of the fourth connecting section are connected with the body portion and spaced apart from each other to form the second engaging groove with a second engaging notch; and
the first engaging groove and the second engaging groove are dovetail-shaped, the first engaging protrusion is formed on an end face of the first plate and configured to be dovetail-shaped to be adapted to the first engaging groove, and the second engaging protrusion is formed on an end face of the second plate and configured to be dovetail-shaped to be adapted to the second engaging groove.

10. The plate connection assembly according to claim 9, wherein the first engaging groove and the second engaging groove are staggered or partially overlapped in an opening direction of the first engaging notch, and the first engaging groove and the second engaging groove are staggered in an opening direction of the second engaging notch.

11. The plate connection assembly according to claim 1, wherein the first connecting part and the second connecting part are symmetrically arranged.

12. The plate connection assembly according to claim 1, wherein at least one of the first connecting part and the third connecting part is provided with a first convex tooth on an engaging surface thereof, and at least one of the second connecting part and the fourth connecting part is provided with a second convex tooth on an engaging surface thereof.

13. A connector for connecting plates, comprising a first connecting part and a second connecting part, wherein the first connecting part extends along a length direction of the connector and is configured to be engaged with a first plate, the second connecting part extends along the length direction of the connector and is configured to be engaged with a second plate, the first connecting part comprises a first engaging groove or a first engaging protrusion, and the second connecting part comprises a second engaging groove or a second engaging protrusion.

14. The connector according to claim 13, wherein,
the connector comprises a body portion, a first connecting section, a second connecting section, a third connecting section and a fourth connecting section;
the body portion comprises a first body section, a second body section and a third body section, wherein a first inner end of the first body section, a second inner end of the second body section and a third inner end of the third body section are connected with each other;
a first connection end of the first connecting section and a third connection end of the third connecting section are respectively connected with a first outer end of the first body section and located on both sides of the first body section, a second connection end of the second connecting section is connected with a second outer end of the second body section, and a fourth connection end of the fourth connecting section is connected with a third outer end of the third body section;
the first connecting section, the first body section, the second body section and the second connecting section constitute the first connecting part and define the first engaging groove with a first engaging notch; and
the third connecting section, the first body section, the third body section and the fourth connecting section constitute the second connecting part and define the second engaging groove with a second engaging notch.

15. The connector according to claim 14, wherein an included angle between the first body section and the second body section is between 120 degrees and 150 degrees, an included angle between the first connecting section and the first body section is between 15 degrees and 85 degrees, and an included angle between the second connecting section and the second body section is between 15 degrees and 85 degrees.

16. The connector according to claim 13, wherein,
the connector comprises a body portion, a first connecting section and a third connecting section;
the body portion comprises a first body section, a second body section and a third body section, wherein a first inner end of the first body section, a second inner end of the second body section and a third inner end of the third body section are connected with each other;
a first connecting end of the first connecting section and a third connecting end of the third connecting section are respectively connected with a first outer end of the first body section and located at both sides of the first body section;
the first connecting section, the first body section and the second body section constitute the first connecting part and define the first engaging groove with a first engaging notch; and
the third connecting section, the first body section and the third body section constitute the second connecting part and define the second engaging groove with a second engaging notch.

17. The connector according to claim 13, wherein,
the connector comprises a first connecting section, a second connecting section, a third connecting section, a fourth connecting section and a generally rectangular body portion;
a first connecting end of the first connecting section and a second connecting end of the second connecting section are connected with the body portion and spaced apart from each other to form the first engaging groove with a first engaging notch;
a third connection end of the third connecting section and a fourth connection end of the fourth connecting section are connected with the body portion and spaced apart from each other to form the second engaging groove with a second engaging notch;
the first engaging groove and the second engaging groove are dovetail-shaped; and
the first engaging protrusion is formed on an end face of the first plate and configured to be dovetail-shaped to be adapted to the first engaging groove, and the second engaging protrusion is formed on an end face of the second plate and configured to be dovetail-shaped to be adapted to the second engaging groove.

18. The connector according to claim 13, wherein the first connecting part is provided with a first convex tooth on an engaging surface thereof, and the second connecting part is provided with a second convex tooth on an engaging surface thereof.

19. A box, comprising a bottom plate, a plurality of side plates and a plurality of connectors, wherein the plurality of side plates are connected with the bottom plate, adjacent side plates comprise a first plate and a second plate, and adjacent ends of the first plate and the second plate are connected with each other through the connector,
wherein the connector comprises a first connecting part and a second connecting part extending along a length direction of the connector;
the first plate has a third connecting part adjacent to an end of the first plate and extending in a width direction of the first plate, and the second plate has a fourth connecting part adjacent to an end of the second plate and extending in a width direction of the second plate; and
the third connecting part is engaged with the first connecting part, and the fourth connecting part is engaged with the second connecting part.
